(19) United States
(12) Patent Application Publication
(10) Pub. No.: US 2026/0346345 A1
(43) Pub. Date: Nov. 5, 2026

(54) PERIMETER SURFACE WORKING TOOL FOR HOLE SAW

(71) Applicant: Bradley J. Ebner, Winnipeg (CA)

(72) Inventor: Bradley J. Ebner, Winnipeg (CA)

(21) Appl. No.: 19/487,164

(22) PCT Filed: May 22, 2024
(86) PCT No.: PCT/CA2024/050680

§ 371 Date: Nov. 24, 2025

(51) Int. Cl. B23B 51/04

(52) U.S. Cl. CPC B23B 51/0417; B23B 51/0467

(57) ABSTRACT

An attachment is provided for a hole saw used in forming a hole into a body of material in which the attachment removes material from the surface of the body surrounding the hole while the hole is being cut. The attachment has a mounting body that is arranged to be removably mounted onto the saw blade body of the hole saw. A working body to protrudes radially from the mounting body on the saw blade at an intermediate location spaced axially inward from the saw teeth. For example, when using the hole saw to cut a hole for mounting recessed pot lights in a stippled ceiling, the working body acts to remove the stipple material from an annular surface portion of the body surrounding the circular hole the hole saw is rotated to form the circular hole. A peripheral flange of the lighting fixture can then be snuggly fit against the ceiling in the annular region where the stipple has been removed.

### FIELD OF THE INVENTION

The present invention relates to a tool for mounting onto a hole saw that cuts holes into a supporting surface in which the tool engages a perimeter surface about the cut hole while cutting the hole, for example to form a counter bore about the cut hole or to remove surface texture from the supporting surface about a perimeter of the cut hole.

### BACKGROUND

When mounting recessed lighting fixtures in a ceiling, it is common to use a hole saw to form a hole in the ceiling that receives a base of the mounted lighting fixture therein. A trim flange on the lighting fixture overlaps the ceiling about the perimeter of the cut hole, but when the ceiling is textured, for example in the instance of a stippled ceiling, the trim flange does not sit snuggly against the ceiling leaving an unfinished gap about the trim flange of the lighting fixture. Currently, installers must manually sand and scrape the ceiling to remove a strip of the ceiling texture surrounding the cut hole, but this is time consuming and reliant on skill of the installer to obtain a properly finished appearance once installed.

### SUMMARY OF THE INVENTION

According to one aspect of the invention there is provided a surface working apparatus for a hole saw having a mounting shaft and a saw blade body occupying at least part of a cylindrical boundary that is concentric about the mounting shaft in which the saw blade extends axially from a mounting end connected to the shaft to a working end locating saw teeth thereon to form a circular hole in a supporting surface, the apparatus comprising:
a mounting body arranged to be mounted fixedly on the saw blade body; and
a working body supported by the mounting body to protrude radially from the saw blade at an intermediate location-based axially inward from the saw teeth whereby the working body is arranged to remove material from an annular surface portion of the supporting surface about the circular hole in the supporting surface as the hole saw is rotated to form the circular hole.

Preferably the mounting body is adjustable relative to the saw blade in an axial direction.

Preferably the mounting body comprises an annular collar arranged to extend about a full circumference of the saw blade.

Preferably the apparatus further comprises a set screw threaded into the mounting body so as to be to selectively fix the mounting body movably relative to the saw blade.

Preferably the working body is annular in shape so as to be arranged to extend about a full circumference of the saw blade.

Preferably the working body defines a working surface at an outermost end of the apparatus in the axial direction in which the working surface lies perpendicular to an axis of rotation of the apparatus when mounted on the hole saw.

Preferably the working body supports a working member thereon including grit formed on the working member.

Preferably the working member includes a releasable attachment layer arranged to releasably support the working member on the working body.

### BRIEF DESCRIPTION OF THE DRAWINGS

Some embodiment of the invention will now be described in conjunction with the accompanying drawings in which:

FIG. 1 is a perspective view of the surface working apparatus according to a first embodiment and a hole saw onto which the apparatus is intended to be mounted;

FIG. 2 is a perspective view of the apparatus according to the first embodiment of FIG. 1, shown mounted on a hole saw in preparation of cutting a hole in a supporting surface;

FIG. 3 is a perspective view of the apparatus according to the first embodiment of FIG. 1, shown mounted on the hole saw as the hole saw cuts a hole in the supporting surface and the apparatus simultaneously removes material from an annular surface portion surrounding the cut hole;

FIG. 4 is a perspective view of the cut hole formed by the hole saw and the counterbore of surface texture removed from the annular surface portion surrounding the cut hole after removal of the hole saw and the apparatus according to the first embodiment of FIG. 1;

FIG. 5 is a perspective view of a recessed lighting fixture aligned with the cut hole after the hole saw and the apparatus according to the first embodiment of FIG. 1 are removed;

FIG. 6 is a perspective view of the installed recessed lighting fixture;

FIG. 7 is a sectional view of the apparatus mounted on a hole saw in preparation of cutting a hole in a supporting surface according to the first embodiment of FIG. 1;

FIG. 8 is a sectional view of the apparatus according to the first embodiment of FIG. 1, shown mounted on the hole saw as the hole saw cuts a hole in the supporting surface and the apparatus simultaneously removes material from an annular surface portion surrounding the cut hole;

FIG. 9 is a sectional view after the hole saw and the apparatus according to the first embodiment of FIG. 1, shown have fully cut the hole and removed the material from the annular surface portion;

FIG. 10 is a sectional view of the cut hole formed by the hole saw and the counterbore of surface texture removed from the annular surface portion surrounding the cut hole after removal of the apparatus and the hole saw from the supporting surface, according to the first embodiment of FIG. 1;

FIG. 11 is a sectional view of a recessed lighting fixture aligned with the cut hole after the hole saw and the apparatus are removed according to the first embodiment of FIG. 1;

FIG. 12 is a sectional view of the installed recessed lighting fixture; and

FIG. 13 is a perspective view of an alternate embodiment of the apparatus in which the mounting body is retained on the hole saw by interference fit instead of a set screw.

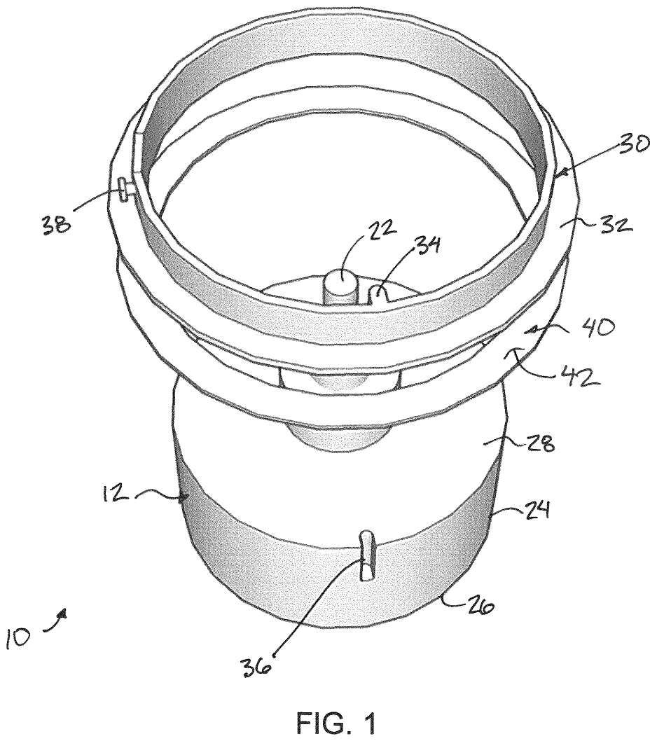

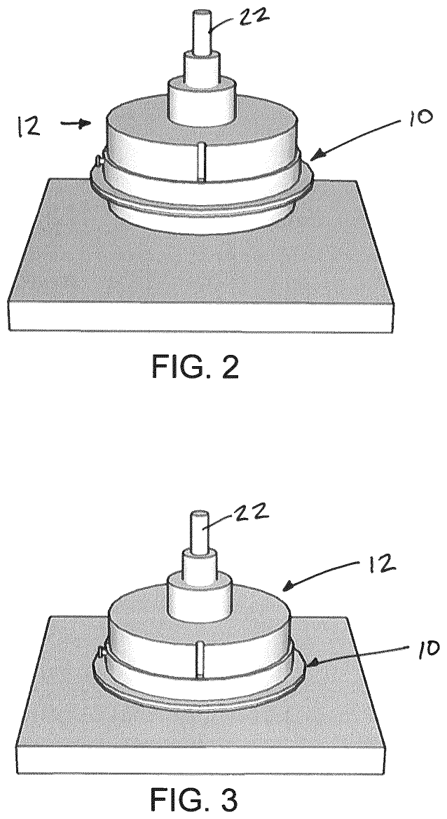

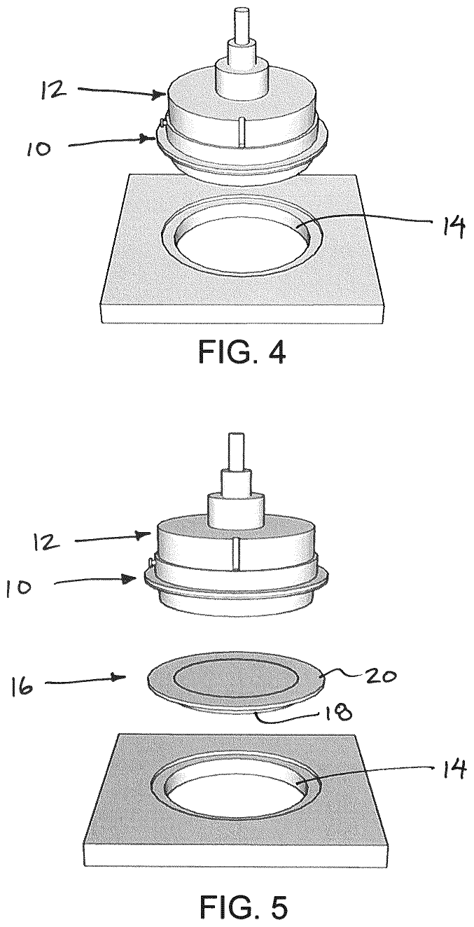

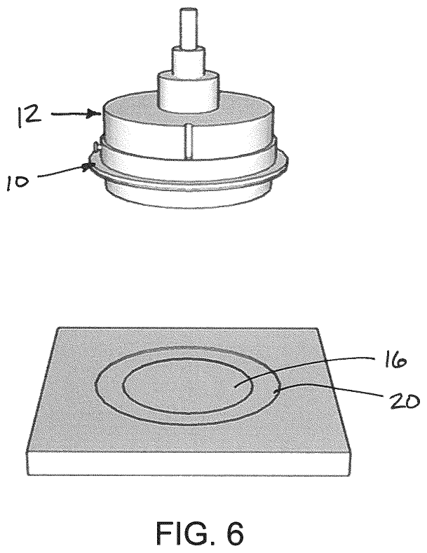

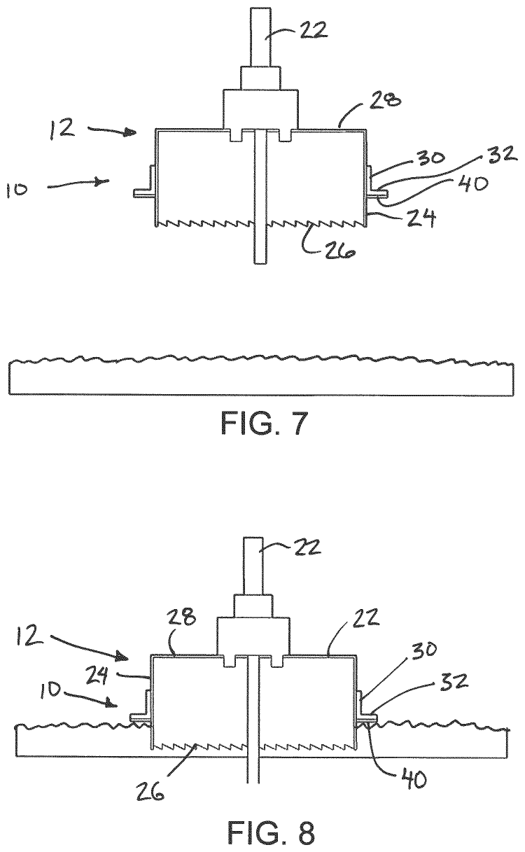

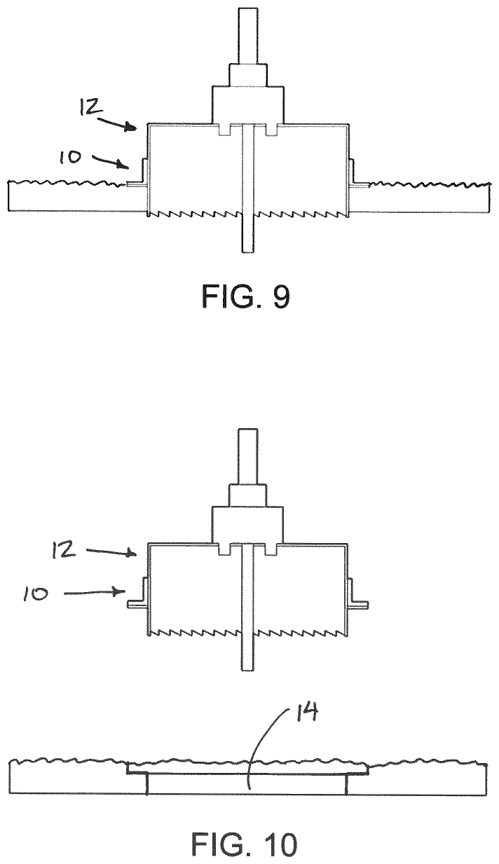

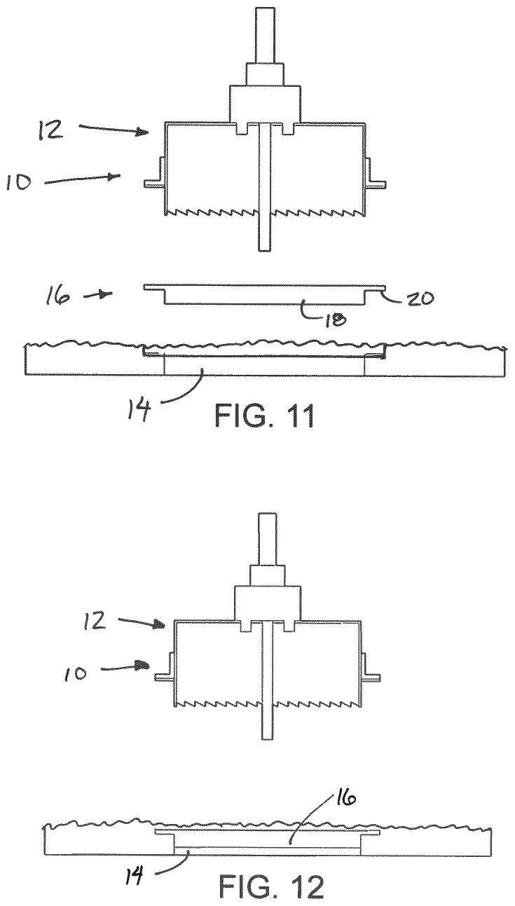

In the drawings like characters of reference indicate corresponding parts in the different figures.

### DETAILED DESCRIPTION

Referring to the accompanying figures there is illustrated a surface working apparatus generally indicated by reference numeral 10. The apparatus 10 is particularly suited for use with a hole saw 12 used for cutting holes in various supporting surfaces. In one application, a cut hole 14 is formed in a drywall sheet forming a ceiling for receiving a recessed lighting fixture 16 therein. The lighting fixture typically has a main body portion 18 having a collar with an outer diameter size to fit within the cut hole 14 and a trim flange 20 protruding radially outward from the bottom of the body 18 for overlapping a surrounding portion of the supporting surface about the perimeter of the cut hole when the base of the lighting fixture is installed within the cut hole.

A typical hole saw includes a shaft 22 that is arranged for mounting within the chuck of a rotary tool such as a drill. The shaft 22 extends axially in a first direction from a free end at one end of the hole saw to an opposing end supporting a saw blade portion 24 of the hole saw thereon. The saw blade 24 is typically formed of sheet metal which is shaped to define a generally cylindrical boundary which may be continuous in the circumferential direction or may include one or more gaps. The saw blade extends axially in the first direction from an inner end mounted on the shaft 22 to an opposing outer working end that supports a plurality of saw teeth 26 thereon which protrude axially from the saw blade at circumferentially spaced positions. The inner end of the saw blade includes a circular plate 28 spanning radially between the shaft 22 and the inner end of the saw blade 24 to mount the saw blade concentrically on the shaft for rotation together when driven by the rotary tool.

The apparatus 10 generally includes a mounting body 30 for mounting externally on the saw blade 24 of the hole saw and a working body 32 supported by the mounting body to protrude radially outward at the outer end of the apparatus in the axial direction. The working body is intended to engage the supporting surface about the periphery of the cut hole as the saw blade forms the cut hole.

According to the illustrated embodiment, the mounting body 30 comprises a collar having an interior diameter that closely fits the outer diameter of the saw blade 24 of the hole saw. Optionally the collar may include a key 34 protruding radially inward from the inner diameter of the collar for mating with a corresponding axially extending key slot 36 formed in the outer surface of the saw blade 24. The mating of the key 34 within the key slot 36 assists in fixing the apparatus relative to the saw blade and transfers torque from the saw blade to the apparatus so that they rotate together when the rotary tool is operated.

A set screw 38 is also threaded into a corresponding bore extending radially through the mounting body 30 for engaging a corresponding portion of the outer surface of the saw blade at various positions of the mounting body relative to the saw blade. In this manner the set screw can be released to allow the apparatus to be axially slidable along the saw blade, followed by tightening of the set screw to lock and immovably fix the mounting body 30 relative to the saw blade at a selected depth in the axial direction from the saw teeth 26 at the working end of the saw blade.

The working body 32 in the illustrated embodiment is an annular flange extending about the full circumference of the saw blade at the outermost end of the mounting body so that the outer end of the annular flange defines a flat working surface that is annular in shape and that lies perpendicularly to the axis of rotation of the full saw. The annular flange spans the full radius of the apparatus at the outermost end of the apparatus such that the working surface defines the maximum radius of the apparatus.

In some instances, the working body 32 may include grit incorporated directly into the working surface so that the working surface functions to directly engage the outer surface portion of the supporting surface that surrounds the cut hole for working the supporting surface to remove material and texture therefrom and/or form a counterbore about the cut hole into which the trim flange 20 of a lighting fixture can be recessed. Accordingly, the radius of the working surface is selected to be equal to or only very slightly greater than the diameter of the trim flange of the corresponding lighting fixture.

In the illustrated embodiment, the working body 32 further supports a working member 40 thereon in which the working member comprises an annular sheet that fully spans the working surface of the working body 32 so that the sheet is mounted perpendicularly to the axis of rotation of the tool in a mounted position. A backing layer 42 is mounted on the inner surface of the sheet forming the working member 40 in the form of hook or loop fasteners for cooperating with corresponding hook or loop fasteners on the working surface of the working body 32 so that the working member 40 can be releasably and replaceably mounted onto the working body 32.

In further embodiments the backing layer may comprise an adhesive layer with a peelable backing sheet allowing the working member to be mounted by peeling and sticking the working member onto the working surface of the working body. A suitable grit of a selected particle size is carried on the outer side of the working member in the conventional manner of sandpaper available in different grit sizes. A radius of the working member is approximately equal to the radius of the trim flange of the lighting fixture.

The apparatus 10 may be available in a plurality of different sizes so that the user selects the apparatus having the size that corresponds to the hole saw and trim flange sizes of the selected lighting fixture. In some instances, a common mounting body 30 may support a plurality of different working bodies or different working members 40 on a common working body so that different radiuses of surface texture can be removed from the ceiling about a common sized cut hole to accommodate different sized trim flanges for different lighting fixtures with the same cut hole size requirement.

The apparatus 10 is used by initially attaching the mounting body onto the exterior of the saw blade of a hole saw with the set screw 38 being used to select the depth of the working member 40 from the saw teeth 26 in the axial direction. The depth is selected to be equal to or greater than the thickness of the sheet panel material through which a cut hole 14 is desired to be formed. The user then operates the hole saw in the normal manner to form a cut hole to receive the base of a lighting fixture therein, however, the operator continues to operate the rotary tool supporting the hole saw thereon until the working member 40 engages and removes texture from the surrounding area about the cut hole. Once a sufficient amount of the surface texture has been removed from the ceiling to create a level surface, the lighting fixture can be mounted in the usual manner with the trim flange of the lighting fixture being recessed into the counterbore formed by the working member 40.

In further embodiments, the working body may take the form of one or more bars or blades which protrude radially from the saw blade in a mounted position to similarly engage and remove texture from an annular portion of the supporting surface surrounding the cut hole 14 that is formed by the saw blade 24 of the hole saw. When the working body comprises a bar or blade supported to extend radially from the saw blade, the working body again operates by rotating with the hole saw as it engages the supporting surface, but the counterbore in the supporting surface is instead formed by a scraping or cutting action rather than a sanding action using grit.

As described herein, the invention relates to a device for removing ceiling texture material underneath the trim of a recessed light. When slid over a hole saw being used for making holes for lighting installations, the device allows for the flattening of the surrounding radius of ceiling texture by means of a replaceable abrasive ring that would otherwise prevent the light from sitting flush to the ceiling. This action takes place during the rotating motion of the device and its abrasive material, that is piggybacking off the rotation of the hole saw that the operator is already using to make the hole for the light.

The device has a shallow plastic sleeve with a rim that slides over a hole saw to be used along with an abrasive ring that secures to the rim by means of hook and loop that will remove ceiling texture material to a specific radius as the installer operates a drill equipped with the hole saw and correspondingly-sized device for each size of light that are available.

When slid over a hole saw being used with a drill for making holes in drywall and plaster ceilings for new recessed lighting installations in standard trade sizes, with a device made for each size of hole saw, the rotating motion of the hole saw allows the ring's abrasive material to flatten the surrounding texture to permit the light to sit flush and tight to the actual surface of the ceiling.

The device includes the shallow plastic sleeve with the rim and the abrasive rings. The abrasive rings will fasten to the rim of the device by means of the device and rings both being made with hook and loop material on their mating surfaces.

The device requires the operator to have a drill for making holes and the required size of hole saw for the lighting size. Standard sized for lights are 4″, 5″, and 6″, and a device will be made for the proper size hole saw for each the device will slide over bringing its surface just back from the ceiling surface as the operator runs the drill, with the abrasive ring's rotation during cutting of the hole for the light which will remove the surrounding texture to allow for the light's trim to sit flush to the ceiling when they are installed.

The device quickly and neatly removes the ceiling texture that prevents recessed lights from sitting flush and allows for installers, both professional and do-it-yourself-types to reduce install times and give an effective and efficient way to do so.

The present invention relates to a device and a method associated with the device. With respect to the device, it is a plastic sleeve and abrasive ring, which slides over a hole saw to be used for making holes for recessed lighting installations. The plastic sleeve has a lip that the user affixes abrasive rings to, to remove ceiling texture.

This device can be used to remove the ceiling texture that is beneath recessed light trims at the time of the hole being made for new lighting installations

The core components of the invention are a shallow plastic sleeve with rim, and an abrasive ring which, generally speaking, are configured as follows. The abrasive ring secures to the face of the rim of the plastic sleeve by means of a hook and loop material.

With respect to the associated method, In order to carry out the method the following core steps are followed: Operator installs the proper-sized sleeve on the corresponding hole saw for the light size being used, which is to be used with a drill. Operation of the drill and the rotation of the hole saw rotates the device's attached abrasive material to flatten ceiling texture as hole is made.

Ultimately, at the conclusion of these steps, the surrounding ceiling texture that would otherwise be beneath the light's trim is mostly-removed allowing for the light to sit flush to the ceiling's surface.

It would be desirable to have a device that could remove ceiling texture around the rim of an opening for recessed lights, which when it was finished a nice, circular clearing was made for the light to sit flush to the ceiling. Furthermore, it would also be desirable to have a device that was made in various sizes for the numerous sizes of lights available to consumers and professional tradespeople. Still, further, it would be desirable to have a device that used replaceable abrasive rings in various grits to remove light or heavier textured ceiling material. Therefore, there currently exists a need in the industry for a device that allows for the efficient and neat removal of ceiling texture under recessed lighting trims. Similarly, it would be desirable to have an associated method that allowed for the removal of the ceiling texture at the time of operating a drill and a hole saw with the device slid over it. Therefore, there currently exists a need for a process that allows the installer to clear away ceiling texture simultaneously while making holes for lights.

It would be desirable to have a device that could remove ceiling texture around the rim of an opening for recessed lights, which when it was finished a nice, circular clearing was made for the light to sit flush to the ceiling. Furthermore, it would also be desirable to have a device that was made in various sizes for the numerous sizes of lights available to consumers and professional tradespeople. Still, further, it would be desirable to have a device that used replaceable abrasive rings in various grits to remove light or heavier textured ceiling material. Therefore, there currently exists a need in the industry for a device that allows for the efficient and neat removal of ceiling texture under recessed lighting trims. Similarly, it would be desirable to have an associated method that allowed for the removal of the ceiling texture at the time of operating a drill and a hole saw with the device slid over it. Therefore, there currently exists a need for a process that allows the installer to clear away ceiling texture simultaneously while making holes for lights.

Disclosed is a ceiling texture removal device, which is made up of the following components. There is a shallow plastic sleeve that has a rim with hook and loop material affixed to its forward-facing surface, and a ring of abrasive material with hook and loop material on the back of it. These components are connected as follows: the ring of abrasive material is affixed to the face of the sleeve's rim by means of the hook and loop surfaces the two components have. The associated method is made up of the following steps. The operator slides the desired sleeve over the proper hole saw for the specific size needed for the install, and then inserts the hole saw into the chuck of a drill. The operator will slide the sleeve so it is back from the cutting teeth of the hole saw by approximately ½″ and will drill the hole for the light and have the device and it's attached abrasive material remove the ceiling texture as the hole is made for the light as it rotates in unison with the hole saw. After the light's driver is wired, the light can be installed and it will sit flush to the ceiling with the area beneath its trim having been cleared away by the device.

The device may have one of more of the following: a means to secure the device to the hole saw at a desired depth with a set screw to put pressure inwards against the wall of the hole saw, swappable rims that could be changed to allow for one sleeve to accommodate multiple texture removal radii to be made for a tight fit for different brands' lights and the differing diameter of their trims. The device may also be made to be capable of accommodating different-sized hole saws by needing only one device that can expand for larger holes and be made smaller for smaller holes. The device may also be made using no abrasive material, instead having a texture built into the actual design of the rim's surface. A new design of hole saw could also be made to incorporate the required rim for affixing abrasive material, that could be slid up and down the hole saw in a groove that has a key on the inside edge of the plastic ring to index in the slot.

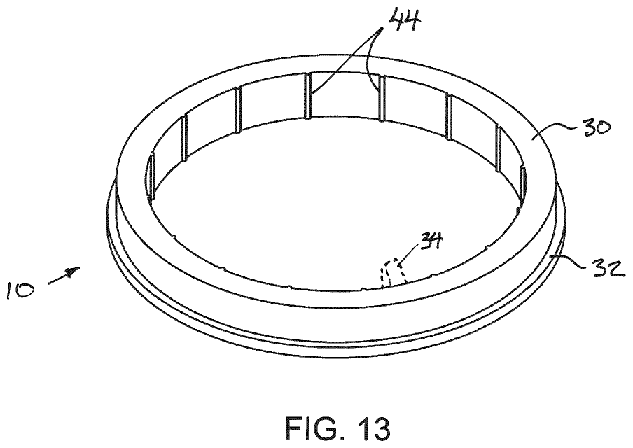

Turning now to a further embodiment shown in FIG. 13, the apparatus 10 may again comprise a collar defining a mounting body 30 supporting a radially protruding flange that defines a working body 32 similarly to the previous embodiments. The mounting body 30 in this instance may have an inner diameter that is slightly larger than the outer diameter of the cylindrical blade body 24, but the inner surface in this instance includes a plurality of radially inwardly protruding members 44 such as lugs or axially oriented ribs which extend inward from the inner surface. A circumference of a circle connected between the inner ends of the protruding members has a diameter that is slightly smaller than the outer diameter of the saw blade body 24 so that the mounting body 30 must be press-fit onto the saw blade body 24 by interference fit. The friction generated by the interference fit is sufficient to hold the apparatus 10 mounted on the hole saw 12 while enabling the apparatus to be removed by overcoming the friction. A key 34 that fits into a corresponding recess within the saw blade according to the previous embodiment may optionally be used in this instance to assist in transferring torque from the hole saw 10 to the apparatus. In the embodiment of FIG. 13, the working body 32 supports a working member 40 thereon similarly to the previous embodiment.

Since various modifications can be made in the invention as herein above described, and many apparently widely different embodiments of same made, it is intended that all matter contained in the accompanying specification shall be interpreted as illustrative only and not in a limiting sense.

1. A surface working apparatus for a hole saw having a mounting shaft and a saw blade body occupying at least part of a cylindrical boundary that is concentric about the mounting shaft in which the saw blade extends axially from a mounting end connected to the shaft to a working end locating saw teeth thereon to form a circular hole in a supporting surface, the apparatus comprising:
a mounting body arranged to be mounted fixedly on the saw blade body; and
a working body supported by the mounting body to protrude radially from the saw blade at an intermediate location spaced axially inward from the saw teeth whereby the working body is arranged to remove material from an annular surface portion of the supporting surface about the circular hole in the supporting surface as the hole saw is rotated to form the circular hole.

2. The apparatus according to claim 1 wherein the mounting body is adjustable relative to the saw blade in an axial direction.

3. The apparatus according to claim 1 wherein the mounting body comprises an annular collar arranged to extend about a full circumference of the saw blade.

4. The apparatus according to claim 1 wherein the working body is annular in shape so as to be arranged to extend about a full circumference of the saw blade.

5. The apparatus according to claim 1 wherein the working body defines a working surface at an outermost end of the apparatus in the axial direction in which the working surface lies perpendicular to an axis of rotation of the apparatus when mounted on the hole saw.

6. The apparatus according to claim 1 wherein the working body supports a working member thereon including grit formed on the working member.

7. The apparatus according to claim 1 wherein the working member includes a releasable attachment layer arranged to releasably support the working member on the working body.

8. The apparatus according to claim 1 wherein the apparatus further comprises a set screw threaded into the mounting body so as to be to selectively fix the mounting body movably relative to the saw blade.

9. The apparatus according to claim 1 wherein the mounting body is arranged to receive the saw blade therein by interference fit so as to retain the mounting body supported on the saw blade by friction.
